(19) United States
(12) Patent Application Publication
(10) Pub. No.: US 2024/0206365 A1
(43) Pub. Date: Jun. 27, 2024

(54) MODULAR APPARATUS AND METHOD OF OPERATING THE MODULAR APPARATUS

(71) Applicant: Tartan Aerial Sense Tech Private Limited, Bangalore (IN)

(72) Inventors: Prakash Mathews Pothen, Thiruvalla (IN); Varun S. Kumar, Bangalore (IN); Rajan P, Ilayangundi (IN); Ankush Ashok Gudape, Darwha (IN)

(21) Appl. No.: 18/394,601

(22) Filed: Dec. 22, 2023

(30) Foreign Application Priority Data
Dec. 26, 2022 (IN) 202241075499

(51) Int. Cl. A01B 76/00; A01B 79/02; G06T 7/136; G06T 7/174; G06T 7/246

(52) U.S. Cl. CPC A01B 76/00; A01B 79/02; G06T 7/136; G06T 7/174; G06T 7/251; G06T 2207/10016; G06T 2207/20081; G06T 2207/20084; G06T 2207/30188

(57) ABSTRACT

A modular apparatus mounted in a vehicle that includes an image-capture device that further includes a printed circuit board (PCB) having a perforation to accommodate an image-sensor and a plurality of layers of strobe-lights to surround the image-sensor. The modular apparatus includes a control device to control the image-capture device and determine a plurality of time instants at which the image-sensor and the plurality of layers of strobe-lights are activated. Furthermore, the control device captures a sequence of images of a field-of-view (FOV) of a defined area of a field at the determined plurality of time instants. Thereafter, the control device detects and tracks a crop plant in the defined area and generate a bounding box around the crop plant that is tracked. Further, the control device detects a plurality of buffer values and cause an implement to perform a predefined action on the crop plant.

### CROSS-REFERENCE TO RELATED APPLICATIONS/INCORPORATION BY REFERENCE

This Patent Application makes reference to, claims the benefit of, and claims priority to an Indian Patent Application No. 202241075499, filed on Dec. 26, 2022, which is incorporated herein by reference in its entirely, and for which priority is hereby claimed under the Paris Convention and 35 U.S.C. 119 and all other applicable law.

### TECHNICAL FIELD

The present disclosure relates generally to the field of agricultural machines and systems; and more specifically, to a modular apparatus for an agricultural application and a method of operating the modular apparatus.

### BACKGROUND

With the rapid advancement of machines, agricultural implements, special-purpose vehicles, and vehicle mounted apparatus, productivity in agricultural operations have increased. However, existing vehicle-based agricultural systems are very complex in nature, where a particular system or machinery works only when it is from a same manufacturer. In other words, one system of one manufacturer is not compatible with another system of another manufacturer. This binds a farmer to use costly machineries and agricultural implements of one specific manufacturer as crosstalk among different electronics and mechatronics systems is generally restricted or severely limited in use.

There are many other technical problems with conventional systems and methods in terms of how to perform artifact-free image acquisition when a camera is attached at a vehicle that is in motion. In one example, camera-based systems are known to aid in different operations in an agricultural field. However, uneven land area of the agricultural field combined with uncertainty in surrounding environmental conditions while capturing images of agricultural field (e.g., variation in sunlight due to either clouds, rain, a shadow of a large object, like tree, while capturing an image, change in position of sun throughout the day, light intensity, a time of day when farming is done etc.) are found to severely and adversely impact the existing image acquisition systems that are used in agricultural machines or implements. The existing systems either fail or accuracy is severely impacted in such conditions. This causes the conventional machines, systems, and methods to misbehave or causes errors to differentiate between two green looking objects (e.g., crop plants and weeds). In another example, there is a problem of over-engineering, i.e., too many sensor units, too much processing, and very complex machines. In such a situation, the chances of errors are high due to multiple failure points and at the same time makes such machines very costly, power intensive, and processing intensive, which are not suited for many sub-urban, urban, or rural farming conditions and needs. For instance, some existing systems use chlorophyll sensors or detectors to supplement or corroborate the visible-spectrum image-sensors. However, it is still observed the conventional camera systems fail to capture and process images that are artifact-free due to sudden jerks encountered when the vehicle moves in the uneven land area of the agricultural field combined with uncertainty in surrounding environmental conditions.

Further limitations and disadvantages of conventional and traditional approaches will become apparent to one of skill in the art through comparison of such systems with some aspects of the present disclosure as set forth in the remainder of the present application with reference to the drawings.

### SUMMARY

The present disclosure provides a modular apparatus mounted in a vehicle for an agricultural application and a method of operating the modular apparatus mounted in the vehicle. The present disclosure provides a solution to the existing problem of how to perform artifact-free image acquisition when a camera is attached at a vehicle that is in motion. Other technical problems include how to develop an apparatus that can handle capture and processing of images that are artifact-free even if there are sudden jerks when the vehicle moves in the uneven land area of the agricultural field and how to handle uncertainty in surrounding environmental conditions at the same time. An aim of the present disclosure is to provide a solution that overcomes at least partially the problems encountered in prior art and provide an improved modular apparatus for an agricultural application and an improved method for operating the modular apparatus.

These and other advantages, aspects, and novel features of the present disclosure, as well as details of an illustrated embodiment thereof, will be more fully understood from the following description and drawings.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a block diagram that illustrates various exemplary components of a modular apparatus, in accordance with an embodiment of the present disclosure;

FIG. 2 is a diagram illustrating an exemplary scenario of an image-capture device and a control device of a modular apparatus mounted in a vehicle, in accordance with an embodiment of the present disclosure;

FIGS. 3A and 3B are diagrams that illustrates different perspective views of a printed circuit board (PCB) of a modular apparatus, in accordance with an embodiment of the present disclosure;

FIG. 4 is a diagram illustrating an exemplary scenario of setting a defined confidence threshold and camera buffers, in accordance with an embodiment of the present disclosure;

FIG. 5A is an exemplary diagram that represents a generation of a bounding box around a detected and tracked crop plant, in accordance with an embodiment of the present disclosure;

FIG. 5B is an exemplary diagram illustrating detection of a plurality of buffer values, in accordance with an embodiment of the present disclosure;

FIG. 6 is a diagram illustrating an exemplary arrangement of a modular apparatus that is mounted on a vehicle, in accordance with an embodiment of the present disclosure; and

FIGS. 7A and 7B collectively is a flowchart of a method of operation of a modular apparatus mounted in a vehicle, in accordance with an embodiment of the present disclosure.

### DETAILED DESCRIPTION OF THE DISCLOSURE

Certain embodiments of the disclosure may be found in a modular apparatus mounted in a vehicle for an agricultural application and a method of operating the modular apparatus mounted in the vehicle. In one aspect, the present disclosure provides a modular apparatus mounted in a vehicle. The modular apparatus comprises an image-capture device that comprises a printed circuit board (PCB) having a perforation to accommodate an image-sensor. Moreover, the PCB comprises a plurality of layers of strobe-lights and each layer of strobe-lights is distributed on the PCB around the perforation to surround the image-sensor when mounted on the PCB. The modular apparatus further comprises a control device configured to control the image-capture device. The control device is further configured to determine a plurality of time instants at which the image-sensor as well as the plurality of layers of strobe-lights are to be activated and capture a sequence of images of a field-of-view (FOV) of a defined area of a field when the vehicle is in motion at the determined plurality of time instants. The control device of the modular apparatus is further configured to detect and track a crop plant in the defined area from the captured sequence of images using a pre-trained artificial intelligence model and generate a bounding box around the crop plant being tracked and detect a plurality of buffer values associated with the image-sensor. The control device is further configured to cause an implement attached to the vehicle to perform a predefined action on the crop plant based on the generated bounding box and the detected plurality of buffer values.

The disclosed modular apparatus is technically advanced from conventional apparatus and systems in terms of improved operation of capture and processing of images that are artifact-free even if there are sudden jerks when the vehicle moves in the uneven land area of the agricultural field, where artifact-free image acquisition is ensured even if surrounding environmental conditions keep changing. The PCB and various components of the PCB are advantageously arranged in a way to enable capture of a sequence of non-blurry and jerk free images with high detailing for accurate and efficient detection and tracking of one or more crop plants. The above modular apparatus as a whole, is able to handle surrounding environmental conditions, such as variation in sunlight due to either clouds, rain, a shadow of a large object, like tree, while capturing an image, change in position of sun throughout the day, light intensity, a time of day when the modular apparatus is operated etc.) and at the same time is able to capture non-blurry images. This in turn improves the subsequent operations of the modular apparatus and imparts a perceptive ability to adapt to uneven agricultural land and handle surprisingly advanced real-time changes in the surrounding environmental conditions, such as folding of leaves due to wind, drooping of leaves, occlusion by weed, high weed density around the crop plants, and the like.

In an implementation, the control device is further configured to automatically change an extent of an action area of the predefined action by the implement attached to the vehicle based on a change in the plurality of buffer values. The use of the plurality of buffer values associated with the image-sensor simplifies the operation of performing any change in the the extent of an action area. For example, if an end user wants to increase the action area of any operation, such as a perceptive spot chemical spray on an extended action area, the buffer values may be updated to impart this capability to the modular apparatus to control the implement attached to the vehicle.

In a further implementation, the control device is further configured to update the FOV of the image-sensor to a defined value and the plurality of time instants is re-determined based on the updated FOV of the image-sensor. Typically, the FOV of the image-sensor is fixed. However, in certain scenarios, for instance, to capture more area to accommodate more crops at a time, the FOV may be changed. In such a case, the re-determination of the plurality of time instants in real time or near-real time based on the updated FOV of the image-sensor enables to maintain the accuracy and reliability of the functioning of the modular apparatus. For instance, this re-calibration of FOV ensures the capture of artifact-free images even if there are sudden jerks when the vehicle moves in the uneven land area of the agricultural field.

In a further implementation, the PCB has a first surface and a second surface opposite the first surface, and the plurality of layers of strobe-lights are arranged on the first surface and a plurality of capacitors are arranged on the second surface of the PCB. Advantageously, such configuration of the PCB reduces the form factor of the image-capture device and at the same time ensures that there is zero lag in providing adequate power from the plurality of capacitors to the plurality of layers of strobe-lights are arranged on the first surface to allow very high frequency exposure and image capture. In conventional systems, the exposure time for high-quality camera systems is usually 10-20 milliseconds. The exposure time is defined as a time span for which an image sensor of a modern digital camera is actually exposed to the light so as to record an image. In the present disclosure, such exposure time is about 2-4 milliseconds, preferably 3 milliseconds, and thus more high-definition images are quickly captured (i.e., high frequency of image capture) in similar time, say one second, as compared to conventional camera systems. This contributes to nullifying the adverse effects of any jerk or motion artifacts.

In a further implementation, the the plurality of capacitors of the PCB are configured to supply power to the plurality of layers of strobe-lights at the determined plurality of time instants. By virtue of supplying power to the plurality of layers of strobe-lights at only the determined plurality of time instants, active and accurate synchronization between the image sensor operation and light exposure is achieved whereas power is saved for other time periods where image sensor is not operational intermittently.

In a further implementation, the detection and tracking of the crop plant in the defined area from the captured sequence of images is further based on a defined confidence threshold that is indicative of a detection sensitivity related to the crop plant. Moreover, the use of the defined confidence threshold significantly improves the perceptive capability of the modular apparatus such that the detection and the tracking of the crop plant is achieved with improved accuracy and precision for the correct time instants, irrespective of any change in the surrounding environmental conditions while capturing images of agricultural field. For example, an increase or a decrease in the defined confidence threshold dynamically changes the detection sensitivity of the crop plant increasing the perceptive capability of the modular apparatus making the system fail-safe. For instance, sudden change in surrounding conditions, such as leaf folding, leaves drooping, partial occlusion of crop plants by surrounding weeds, high weed density or different weed density around the crop plants etc. can be handled.

In another aspect, the present disclosure provides a method of operation of the modular apparatus mounted in a vehicle. The method of operation of the modular apparatus mounted in a vehicle, comprises determining a plurality of time instants at which the image-sensor as well as the plurality of layers of strobe-lights are to be activated in a modular apparatus. The method of operation of the modular apparatus mounted in a vehicle further comprises capturing a sequence of images of a field-of-view (FOV) of a defined area of a field when the vehicle is in motion at the determined plurality of time instants in the modular apparatus. The method of operation of the modular apparatus mounted in a vehicle further comprises detecting and tracking a crop plant in the defined area from the captured sequence of images using a pre-trained artificial intelligence model in the modular apparatus. The method of operation of the modular apparatus mounted in a vehicle further comprises generating a bounding box around the crop plant being tracked and detect a plurality of buffer values associated with the image-sensor and causing an implement attached to the vehicle to perform a predefined action on the crop plant based on the generated bounding box and the detected plurality of buffer values in the modular apparatus. The method achieves all the advantages and technical effects of the modular apparatus of the present disclosure.

It is to be appreciated that all the aforementioned implementations can be combined. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims. Additional aspects, advantages, features and objects of the present disclosure would be made apparent from the drawings and the detailed description of the illustrative implementations construed in conjunction with the appended claims that follow.

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible. In the following description, reference is made to the accompanying drawings, which form a part hereof, and in which is shown, by way of illustration, various embodiments of the present disclosure.

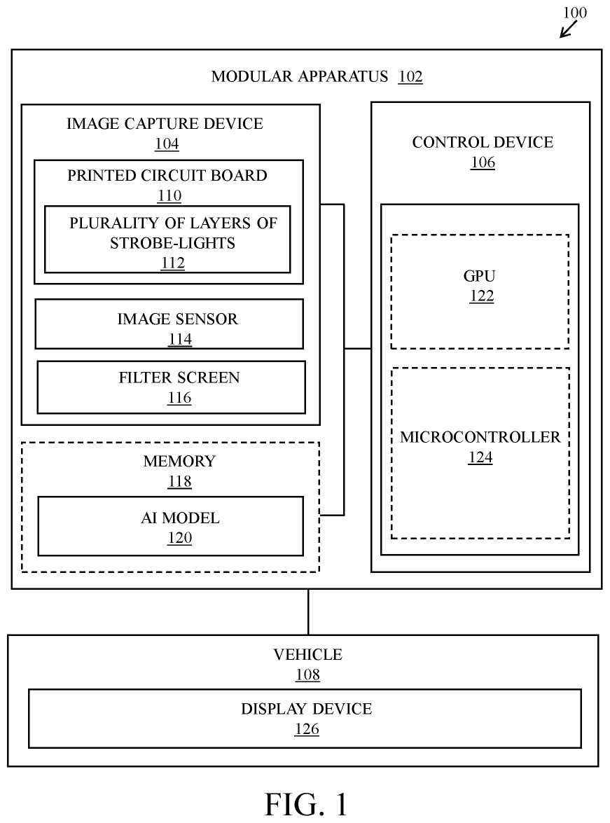

FIG. 1 is a block diagram that illustrates various exemplary components of a modular apparatus, in accordance with an embodiment of the present disclosure. With reference to FIG. 1, there is shown a block diagram 100 that illustrated a modular apparatus 102 and a vehicle 108.

The modular apparatus 102 is mounted in the vehicle 108. The modular apparatus 102 includes an image-capture device 104 that is configured to capture a sequence of non-blurry and jerk-free (e.g., motion-artifacts free) high-quality images to detect and track the crop plant. Moreover, the image-capture device 104 is arranged in a same plane in a downward (i.e., lookdown) position to capture a plurality of field-of-views (FOVs) of a plurality of defined areas of an agricultural field. In an implementation, the image-capture device 104 may be oriented at a specific angle (e.g., 60°) in order to capture a plurality of defined areas of the agricultural field, few metres in forward as well as in downward direction, for example, up to 80-90 cm or up to 1 metre ahead. Examples of the image-capture device 104 may include but not limited to, a RGB camera, a high dynamic range (HDR) camera, and the like. In an implementation, the image-capture device 104 may include a left-side camera (e.g., a RGB camera), a right-side camera, and a central camera without limiting the scope of the present disclosure. In accordance with an embodiment, the image-capture device 104 includes a filter screen 116 to prevent dust particles and UV light to enter the image-sensor 114. The filter screen 116 helps the image-sensor 114 to capture a sequence of images without any hindrance, such as the hindrance due to the dust particles or the hindrance due to the UV light.

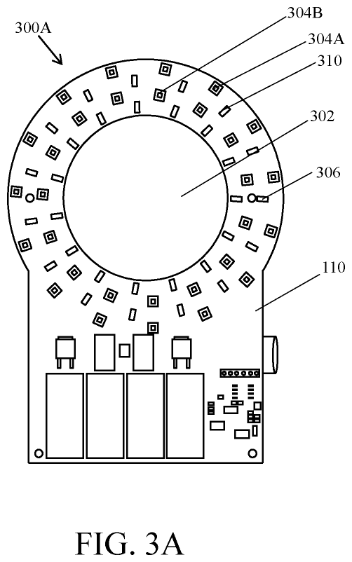

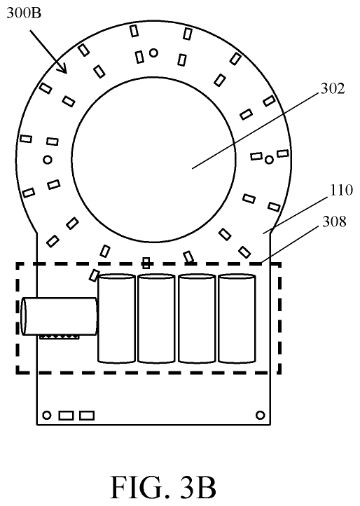

The image-capture device 104 further includes a PCB 110 that includes a perforation to accommodate the image-sensor 114. The perforation refers to a cut-out in the middle of the PCB 110 to accommodate the image-sensor 114. An example of the perforation has been shown in FIGS. 3A and 3B. Furthermore, the PCB 110 further includes the plurality of layers of strobe-lights 112, such as a first layer of strobe-lights and a second layer of strobe-lights. An example of the arrangement of the plurality of layers of strobe-lights 112 is shown in FIG. 3A. The number of layers of the strobe-lights can be increased or decreased in the PCB 110 to increase or decrease the intensity of the light as per the requirement. For example, the number of layers of strobe-lights are increased or more layers may be activated automatically to increase the intensity in order to enable the image-capture device 104 to capture a sequence of images with high intensity during the night-time. Similarly, the number of strobe-lights are decreased to decrease the intensity to avoid excess amount of brightness that can prevent the image-capture device 104 to capture the sequence clear images, such as during the daytime. Each layer of strobe-lights from the plurality of layers of strobe-lights 112 is distributed on the PCB 110 around the perforation to surround the image-sensor 114 when mounted on the PCB 110. For example, the first layer of plurality of strobe-lights is distributed around the perforation on the PCB 110. As result, the plurality of layers of strobe-lights 112 provides a high intensity light source that enables the image-capture device 104 to capture a clear and non-blurry image for the detection of the crop plant.

In operation, the modular apparatus 102 further includes the control device 106 that is configured to control the image-capture device 104. The control device 106 is configured to control the functioning of the image-capture device 104 that is configured to capture the sequence of images. In an implementation, the control device 106 may include a microcontroller 124 that is configured to control a sequence of power supply to the different components of the PCB 110, such as the plurality of layers of strobe-lights 112 and the image-sensor 114. The sequence of power supply is used to provide a desired power supply to the different components of the PCB 110, such as low power to certain components, and high-power supply to the other components. Moreover, examples of the microcontroller 124 may include, but are not limited to an integrated circuit, a co-processor, a microprocessor, a complex instruction set computing (CISC) processor, an application-specific integrated circuit (ASIC) processor, a reduced instruction set (RISC) processor, a very long instruction word (VLIW) processor, a central processing unit (CPU), a state machine, a data processing unit, and other processors or circuits.

Furthermore, the control device 106 is configured to determine a plurality of time instants at which the image-sensor 114 as well as the plurality of layers of strobe-lights 112 are to be activated. The plurality of time instants corresponds to one or more time slots during which the image-sensor 114 is exposed to plurality of strobe-lights 112. In an implementation, the image-sensor 114 is exposed to the plurality of layers of strobe-lights 112 for the plurality of time instants, for example, every 3 milliseconds, during which the image-sensor 114 operation is synchronized with the activation of the plurality of strobe-lights 112. However, the plurality of time instants (or the exposure time) may increase to increase the duration of the activation of the image-sensor 114 and the plurality of strobe-lights 112 or decreased to decrease the duration of the activation of the image-sensor 114 and the plurality of strobe-lights 112. As a result, the image-sensor 114 and the plurality of layers of strobe-lights 112 are activated as well as deactivated during the same duration of time instants to prevent an unnecessary flow of power energy to the plurality of layers of strobe-lights 112 even when the image-sensor 114 is not activated.

The control device 106 is further configured to capture the sequence of images of a field-of-view (FOV) of a defined area of a field when the vehicle 108 is in motion at the determined plurality of time instants. The FOV of the defined area of the field may be set, for example, of 1 meter at 60-degrees to acquire higher resolution and detailing in the captured sequence of images at the determined plurality of time instants when the vehicle 108 is in motion. The plurality of time instants provides enough time for the control device 106 to capture the sequence of jerk-free and non-blurry images of the field-of-view (FOV) of the defined area of the agricultural field to further process the image, for example, for crop detection, crop tracking, distinguishing from weeds, and optionally for the determination of the correct defined confidence threshold. In addition, the control device 106 may include a GPU 122 that is configured to process a sequence of images captured by the image-capture device 104. In an example, the sequence of images captured by the image-capture device 104 are received by the GPU 122 through a camera connection port. Thereafter, the GPU 122 is configured to use a deep learning model to process the sequence of images, such as to resize the size of the sequence of images, which is then used to distinguish between the crop plants and the weeds. In an example, if the images captured the image-capture device may comprise folded leaf, drooping leaves, or party occluded leaves of crop plants. In such cases too, the control device 106 is configured to identify the crop plants with high accuracy and distinguish from the surrounding weeds. In accordance with an embodiment, the control device 106 is configured to update the FOV of the image-sensor 114 to a defined value. Moreover, the plurality of time instants is re-determined based on the updated FOV of the image-sensor 114. For example, the FOV of the defined area is increased from 1 meter to 1.5 meter at 60-degrees, then, in that case, the control device 106 is configured to re-determine the plurality of time instants based on the increased FOV. Typically, the FOV of the image-sensor 114 is fixed. However, in certain scenarios, for instance, to capture more area to accommodate more crops at a time, the FOV may be changed. In such a case, the re-determination of the plurality of time instants in real time or near-real time based on the updated FOV of the image-sensor 114 enables to maintain the accuracy and reliability of the functioning of the modular apparatus 102. For instance, this re-calibration of FOV ensures the capture of artifact-free images even if there are sudden jerks when the vehicle moves in the uneven land area of the agricultural field.

The control device 106 is further configured to detect and track a crop plant in the defined area from the captured sequence of images using a pre-trained artificial intelligence (AI) model, such as AI model 120. Firstly, the image-capture device 104 is configured to detect one or more crop plants in the captured sequence of despite of any variation in the environmental parameters (i.e., variation in sunlight due to either clouds or rain or shadow of a large object). Thereafter, the AI model 120 is used by the control device 106 to extract the features that indicate the physical characteristics, like colour of leaf, leaf-shape, stem shape and size, height of the crop plant, canopy size of the plant growth, and the like from the captured sequence of images. Furthermore, the control device 106 is configured to detect and track the crop plant in the defined area of the agricultural field based on the features extracted. For example, the control device 106 is configured to track location of each individual crop plant in the defined area of the agricultural field and clearly differentiate between two green looking objects, such as to differentiate between the crop plants and the weeds. Alternatively stated, the AI model 120 enhances the accuracy and efficiency of the modular apparatus 102.

In an implementation, the AI model 120 may be stored in a memory 118. In another implementation, the AI model 120 may be disposed outside the memory 118 as a separate module or circuitry and communicatively coupled to the memory 118. Thus, the detection and tracking of a crop plant in the defined area from the captured sequence of images provides an efficient and an accurate detection of the crop plant that further helps to distinguish between the crop plant and the weed.

In accordance with an embodiment, the detection and tracking of the crop plant in the defined area from the captured sequence of images is further based on a defined confidence threshold that is indicative of a detection sensitivity related to the crop plant. The use of the defined confidence threshold significantly improves the perceptive capability of the modular apparatus 102 such that the detection and tracking of the crop plant in the defined area from the captured sequence of images is achieved with improved accuracy and precision irrespective of any change in the surrounding environmental conditions while capturing images of agricultural field. For example, an increase or a decrease in the defined confidence threshold dynamically changes the detection sensitivity of the crop plant increasing the perceptive capability of the modular apparatus 102 making the modular apparatus 102 fail-safe. Moreover, the modular apparatus 102 is perceptive and intelligent enough to adapt to uneven agricultural land, is astutely perceptive to real-time changes in the surrounding environmental conditions, and not dependent on any row-identification. In addition, the use of the defined confidence threshold significantly improves the perceptive capability of the modular apparatus 102 such that the detection and the tracking of the crop plant is achieved with improved accuracy and precision for the correct time instants, irrespective of any change in the surrounding environmental conditions while capturing images of agricultural field. For example, an increase or a decrease in the defined confidence threshold dynamically changes the detection sensitivity of the crop plant increasing the perceptive capability of the modular apparatus 102 making the system fail-safe. For instance, sudden change in surrounding conditions, such as leaf folding, leaves drooping, partial occlusion of crop plants by surrounding weeds, high weed density or different weed density around the crop plants etc. can be handled.

In accordance with an embodiment, the defined confidence threshold is set in real-time or near real-time in the AI model 120 or pre-set in the AI model 120 via a user interface (UI) rendered on a display device 126 of the vehicle. Alternatively, the defined confidence threshold is pre-set via the UI rendered on the display device 126 and is communicatively coupled with the control device 106 of the vehicle 108. In an implementation, the defined confidence threshold is adaptive and may automatically be changed depending on a surrounding environment condition, a crop type, and/or a captured image input from the image-capture device 104. Examples of the surrounding environmental conditions while capturing images of agricultural field may include but are not limited to a variation in sunlight due to either cloud, rain, a shadow of a large object, like tree, in an image, a change in position of sun throughout the day, a change in light intensity, a time of day when farming is done etc, an extent of resistance from mud in the agricultural land.

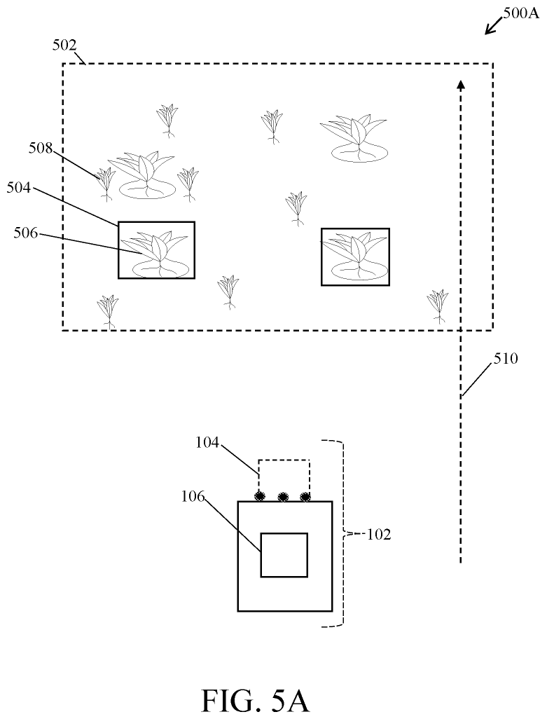

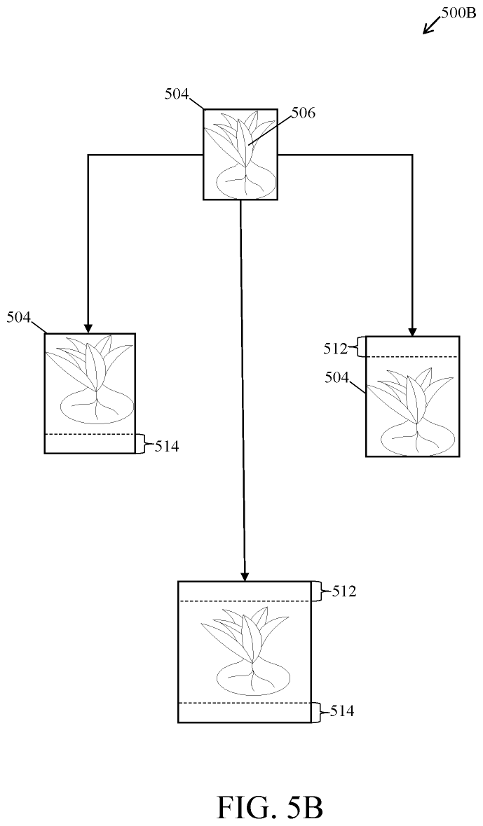

The control device 106 is further configured to generate a bounding box around the crop plant that is tracked. In an implementation, the control device 106 is configured to detect and track the crop plant by using the AI model 120, which is further used to determine the location of each individual crop plant. For example, by collecting geospatial location coordinates obtained by a geospatial sensor provided in a boom arrangement. Thereafter, the location of each individual crop plant is used by the control device 106 to generate the bounding box around each individual crop plant. In an example, the bounding box refers to a border that provides the geospatial location of an object, such as the crop plant. The bounding box is generated by the determination of “X” and “Y” coordinates of the upper-left and the lower-right corner of the rectangular box. The bounding box corresponds to encompassing of an object-of-interest, as further shown, for example, in FIG. 5A. Moreover, the control device 106 is configured to detect a plurality of buffer values associated with the image-sensor 114. In an implementation, the control device 106 is configured to dynamically update the one or more crop regions encompassing the one or more crop plants based on a change in the plurality of buffer values, such as front buffer value and a rear buffer value for the image-capture device 104. In an implementation, the front buffer value, and the rear buffer value of the image-capture device 104 is calculated by analyzing the image data that is receive from the agricultural field. Furthermore, the control device 106 is configured to cause an implement attached to the vehicle to perform a predefined action on the crop plant based on the generated bounding box and the detected plurality of buffer values. In an example, the implement attached to the vehicle may corresponds to a different set of sprayers that are configured to perform a predefined action that is spraying of chemical on the crop plant. In another example, the implement attached to the vehicle may correspond to weeding blades. In such case, the control device 106 is configured to expand the weeding blades to bypass the crop plants while the vehicle is in motion.

In accordance with an embodiment, the control device 106 is further configured to automatically change an extent of an action area of the predefined action by the implement attached to the vehicle based on a change in the plurality of buffer values. In an implementation, the front buffer value from the plurality of buffer values corresponds to a buffer value before which the extent of the action area of the predefined action by the implement can be started. For example, the front buffer value can be used to start spraying over the crop plant when a set of electronically controlled sprayer nozzles are about to go over the crop plant (or withing a first bounding box). Similarly, the rear buffer value can be used to stop spraying over the crop plant when the set of electronically controlled sprayer nozzles have gone over the crop plant (or over a last bounding box or a second bounding box). In an example, the analysis of the data as receive from the agricultural field provides heuristics to arrive at a value for both the front buffer and the rear buffer. Optionally, each of the front buffer value and the rear buffer value ranges from 2 cm to 3 cm. However, the values of the front buffer and the rear buffer can be tuned (i.e., can be increased or decreased) from one field to other field and based on size of the crop plants. Moreover, the front buffer value and the rear buffer value for the image-capture device 104 may be changed automatically by the control device 106 or may be changed through a user input, such as based on the size of the crop plants, condition of the crop plants (e.g., drooping leaves, folded leaves, partly occluded leaves of crop plants, and the like). Therefore, the plurality of buffer values, such as the front buffer value and the rear buffer value for the image-capture device 104 are used by the control device 106 to determine the one or more time slots in advance to automatically perform the predefined action by the implement when the vehicle 108 is in motion. In other words, the plurality of buffer values comprises a front buffer value and a rear buffer value, and where an increase in the front buffer value dynamically extends the action area ahead of the crop in the FOV from a point of view of the image-capture device when the modular apparatus moves towards the crop plant. Similarly, an increase in the rear buffer value dynamically extends the action area behind the crop plant in the FOV from the point of view of the image-capture device when the modular apparatus moves towards the crop plant. The action area may correspond to a spray region comprising the crop plant, where the size of action area increases or decreases when the buffer values are increased or decreased respectively. The modular apparatus 102 may be designed to adjust the area around each crop plant that it targets for treatment (like spraying) based on its position relative to the apparatus. As the vehicle moves, it recalculates this area based on position of crop plant and additional buffer zone due to buffer values, ensuring that treatments are applied accurately and efficiently. The front and rear buffer values allow to adapt the action area depending on the position and movement of the apparatus, thus optimizing the application process, whether it's spraying, harvesting, or any other agricultural activity.

In accordance with an embodiment, the control device 106 is further configured to execute mapping of pixel data of the FOV to distance information from a reference position of the control device 106 when the vehicle is in motion. In contrast to conventional agricultural systems, the control device 106 of the modular apparatus 102 are configured to map pixel level data of weeds or the crop plant in the image to distance information to achieve high accuracy. The distance information signifies the information about the location of weeds and the crop plant from the reference position of the the control device 106 when the vehicle is in motion. That means, how far and in which direction the weeds and the crop plant is located in the agricultural field from the reference position of the the control device 106. Each pixel of the image is mapped to the distance information in millimetres (mm), for example, 1 pixel to 3 mm on real ground, pixel per mm mapping is performed. In accordance with an embodiment, the control device 106 is further configured to update the mapping of the pixel data of the FOV to the distance information based on a change in at least one of the plurality of buffer values. Moreover, the mapping of the image depends on a certain threshold value. If the threshold value is different then, the mapping of the image will be different. In an implementation, a sub-pixel (or a virtual pixel) of each pixel of the image can be considered to achieve more accuracy. As result, the increase in the accuracy enables the image-capture device 104 to capture the jerk free high quality of non-blurry images for the detection of crop plants in the agricultural field.

Thus, the disclosed modular apparatus 102 is technically advanced from conventional apparatus and systems in terms of improved operation of capture and processing of images that are artifact-free even if there are sudden jerks when the vehicle moves in the uneven land area of the agricultural field, where artifact-free image acquisition is ensured even if surrounding environmental conditions keep changing. The PCB and various components of the PCB 110 are advantageously arranged in a way to enable capture of a sequence of non-blurry and jerk free images with high detailing for accurate and efficient detection and tracking of one or more crop plants. The above modular apparatus 102 as a whole, is able to handle surrounding environmental conditions, such as variation in sunlight due to either clouds, rain, a shadow of a large object, like tree, while capturing an image, change in position of sun throughout the day, light intensity, a time of day when the modular apparatus is operated etc.) and at the same time is able to capture non-blurry images. This in turn improves the subsequent operations of the modular apparatus 102 and imparts a perceptive ability to adapt to uneven agricultural land and handle surprisingly advanced real-time changes in the surrounding environmental conditions, such as folding of leaves due to wind, drooping of leaves, occlusion by weed, high weed density around the crop plants, and the like.

Training of the AI model 120: In an implementation, a deep neural network model may be used. For example, in this case, a convolution neural network model may be selected for training purpose. The convolution neural network model may be configured to train on training data of real-word images captured in real agricultural fields of different crops, such as chilli, cotton, lettuce, tomato, potato, cabbage, cauliflower, brinjal, etc. The convolution neural network model was deliberately and specifically trained on crop plants (not weeds and not entire foliage). Images that were representative of different environmental variation and real-life conditions, like uneven land area of the agricultural field, variation in sunlight due to either clouds, rain, a shadow of a large object, like tree, while capturing an image, change in position of sun throughout the day, light intensity, a time of day when farming is done, shadow-on-plant due to any objects, were captured. For example, more than 3 lakhs (e.g. 0.3-1 million images were used to train). Data annotation was done to label the images to identify different elements, such as types of crop plants, age, diseased or healthy plants, discoloured plants, growth stages, shadow-on-plants. A different AI model (CCN model) was used for automatic annotation to create bounding box with annotated parameters. The AI model 120 (i.e., the CNN) learns to extract and learn features from these images through its convolutional layers where golden dataset e.g., a benchmark curated dataset) was used to validate the model's performance and model parameters were adjusted as needed to improve accuracy and reduce overfitting. It was surprisingly observed during validation of the AI model 120 that setting different confidence threshold (0-1 or between 0.1 to 0.99) resulted in surprisingly various advantages in real-world agricultural use case. For instance, at a first defined confidence threshold, say 0.X1, the control device 106 is configured to distinguish between green looking objects, such as crop plants and weeds even if crop plants has shadow falling on it or under different environmental conditions. At a second defined confidence threshold, say 0.X2, the control device 106 is configured to further distinguish between a type of crop plant and a type of weed. At a third defined confidence threshold, say 0.X3, the control device 106 is configured to further distinguish between a diseased or a non-diseased crop plant and further distinguish weeds from such diseased or non-diseased crop plants. At a fourth defined confidence threshold, say 0.X4, the control device 106 is configured to further increase crop detection sensitivity such that a discoloured plant or non-discoloured plant, a growth state of the crop plant, a lack of nutrient etc. can be further sensed and additionally distinguish from weeds. Such detection sensitivity is very advantageous and provides a technical effect of increased perceptiveness of the modular apparatus 102 resulting in improved performance of the modular apparatus 102, such as reduced wastage of chemical used for spraying. Alternatively stated, the use of the defined confidence threshold significantly improves the perceptive capability of the modular apparatus 102 such that the spraying of chemicals is achieved with improved accuracy and precision for the correct time slots, at correct intended areas or spots and only when required with correct amount of spray and correct selection of a type of chemical irrespective of any change in the surrounding environmental conditions while capturing images of agricultural field. For example, an increase or a decrease in the defined confidence threshold dynamically changes the detection sensitivity of the crop plant increasing the perceptive capability of the modular apparatus 102 making the system fail-safe. A right mix of precision and recall value is reflected in a given confidence threshold value. In an example, the control device 106 is configured to determine precision and recall values for different confidence threshold values ranging from 0.1-0.99. The confidence threshold may be selected by identifying and selecting an optimal point in dataset of the precision and recall values that meets the required high recall and at the same time maintaining high enough precision values associated with the detection sensitivity of the AI model 120. When a precision value is highest, the recall value may be lowest. Thus, the right mix of precision and recall value is reflected in a given confidence threshold value.

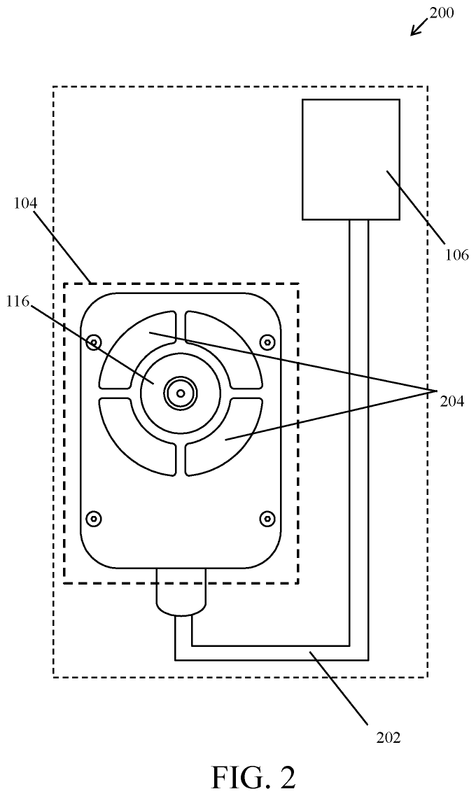

FIG. 2 is a diagram illustrating an exemplary scenario of an image-capture device and a control device of a modular apparatus, in accordance with an embodiment of the present disclosure. FIG. 2 is described in conjunction with elements from FIG. 1. With reference to FIG. 2, there is shown an exemplary scenario 200 that illustrates the image-capture device 104 and the control device 106 of the modular apparatus 102 (of FIG. 1) via a wired medium 202. The image-capture device 104 is configured to capture the sequence of images of a (field-of-view) FOV of a defined area of an agricultural field when the vehicle (i.e., the vehicle 108 of FIG. 1) is in motion. Moreover, the image-capture device 104 includes the filter screen 116 that is used to prevent dust particles and UV light to enter the image-sensor (i.e., the image-sensor 114 of FIG. 1) that is used to provide a non-blurry, high resolution clear sequence of images. Furthermore, the control device 106 is configured to control the image-capture device 104 that is operatively connected to the image-capture device 104 through the connecting wired medium 202. Thus, the control device 106 enables the image-capture device 104 to capture the sequence of images of the FOV to detect and track the crop plant in an agricultural field. There are further shown lighting space 204 where the light from the plurality of layers of strobe-lights 112 is emitted. The operation of the plurality of layers of strobe-lights 112 resemble like blinking where the plurality of layers of strobe-lights 112 are activated at the determined plurality of time instants.

FIGS. 3A and 3B are diagrams that illustrates different perspective views of a printed circuit board (PCB) of a modular apparatus, in accordance with an embodiment of the present disclosure. FIGS. 3A and 3B are described in conjunction with elements from FIGS. 1 and 2. With reference to FIG. 3A, there is shown a a first surface 300A (e.g. a front surface) of the PCB 110. In accordance with an embodiment, the PCB 110 has the first surface 300A and the second surface that is opposite to the first surface 300A. Moreover, the plurality of layers of strobe-lights 112 (FIG. 1), such as a first layer of strobe-light 304A and a second layer of strobe-light 304B are arranged on the first surface. Furthermore, the PCB includes a perforation 302 to accommodate the image-sensor 114 (FIG. 1). The perforation 302 can be a circular or rectangular perforation without limiting the scope of the present disclosure. The perforation 302 is surrounded by the plurality of layers of strobe-lights 112 (FIG. 1), such as the first layer of strobe-lights 304A and the second layer of strobe-lights 304B to provide a lighting source to the image-sensor 114. However, multiple layers of strobe-lights can be increased or decreased in the PCB 110 to increase or decrease the intensity of the light as per the requirement. For example, the number of layers of strobe-lights are increased to increase the intensity in order to enable the image-capture device 104 to capture a sequence of images with high intensity. Similarly, the number of strobe-lights are decreased to decrease the intensity to avoid an excessive amount of brightness that can prevent the image-capture device 104 to capture the sequence non-blurry images. Moreover, the plurality of layers of strobe-lights 112 may also include a plurality of layers of extra slots, such as slots 306 that are provided to further add the plurality of strobe-lights to further increase the brightness of the light. In an example, the first layer of strobe-lights 304A includes an extra space to arrange the plurality of strobe-lights. In another example, the second layer of strobe-light 304B is arranged around the perforation 302 to surround the image-sensor 114. Moreover, the distance between the perforation 302 and the second layer of strobe-light 304B is higher than the distance between the perforation 302 and the first layer of strobe-light 304A. Similarly, the distance between the perforation and the plurality of layers of strobe-lights increases according to the number of layers of strobe-lights included between the layer of strobe-lights and the perforation.

With reference to FIG. 3B, there is shown a second surface 300B (e.g. a rear surface) of the PCB 110. A plurality of capacitors 308 are arranged on the second surface 300B of the PCB 110. In accordance with an embodiment, the plurality of capacitors 308 of the PCB 110 are configured to supply power to the plurality of layers of strobe-lights 112 (of FIG. 1), such as the first layer of strobe-light 304A and the second layer of strobe-light 304B at the determined plurality of time instants. By virtue of supplying power to the plurality of layers of strobe-lights 112 at only the determined plurality of time instants, active and accurate synchronization between the image-sensor 114 operation and light exposure is achieved whereas power is saved for other time periods where image-sensor 114 is not operational intermittently. As a result, the plurality of layers of strobe-lights 112 are configured to provide a flashlight in the determined plurality of time instants (e.g., within 3 ms) to capture a non-blurry sequence of images with an improved pixel density. Therefore, such configuration of the PCB 110 reduces the form factor of the image-capture device 104 and at the same time ensures that there is zero lag in providing adequate power from the plurality of capacitors 308 to the plurality of layers of strobe-lights 112 are arranged on the first surface to allow very high frequency exposure and image capture. In conventional systems, the exposure time for high-quality camera systems is usually 10-20 milliseconds. The exposure time is defined as a time span for which an image sensor of a modern digital camera is actually exposed to the light so as to record an image. In the present disclosure, such exposure time is about 2-4 milliseconds, preferably 3 milliseconds, and thus more high-definition images are quickly captured (i.e., high frequency of image capture) in similar time, say one second, as compared to conventional camera systems. This contributes to nullifying the adverse effects of any jerk or motion artifacts.

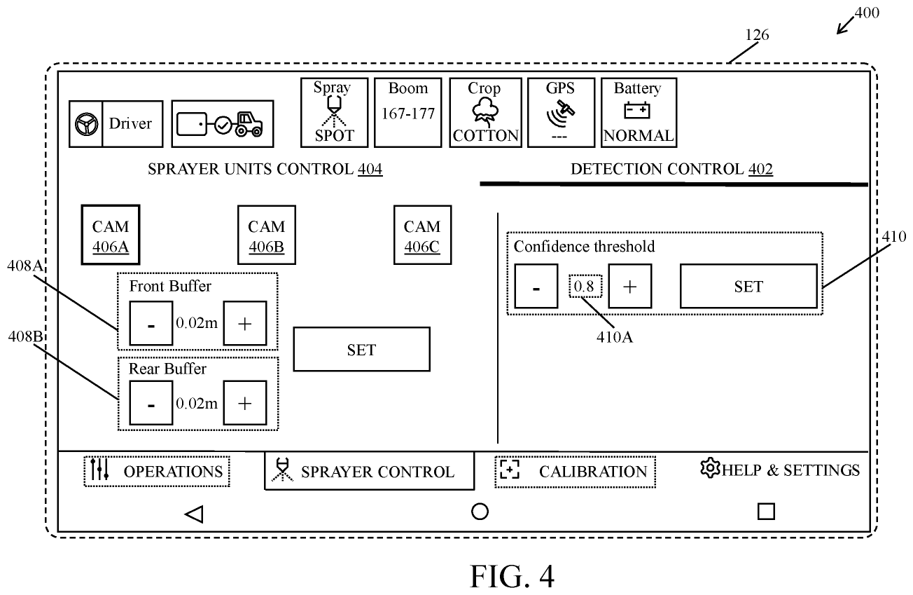

FIG. 4 is a diagram illustrating an exemplary scenario of setting a defined confidence threshold and camera buffers, in accordance with an embodiment of the present disclosure. FIG. 4 is described in conjunction with elements from FIGS. 1, 2, 3A and 3B. With reference to FIG. 4, there is shown an exemplary scenario 400 that illustrates the setting of the defined confidence threshold 410A on the UI rendered on the display device 126. There is further shown different UI elements, such as UI elements 402 to 410, on the UI.

In an implementation, the defined confidence threshold 410A is set in real-time or near real-time in the AI model 120 of the modular apparatus 102. Alternatively, the defined confidence threshold 410A is pre-set via the UI rendered on the display device 126 communicatively coupled to the control device 106. In yet another implementation, the defined confidence threshold 410A is adaptive and may automatically be changed depending on a surrounding environment condition, a crop type, and/or a captured image input from the image-capture device 104. Examples of the surrounding environmental conditions while capturing images of the agricultural field may include, but are not limited to a variation in sunlight due to either cloud, rain, a shadow of a large object, like a tree, in an image, a change in position of the sun throughout the day, a change in light intensity, a time of day when farming is done etc, an extent of resistance from mud in the agricultural field.

In the exemplary scenario 400, the UI element 402 is a detection control that controls the detection sensitivity of the crop plant by calibrating the defined confidence threshold 410A as indicated by the UI element 410. The defined confidence threshold 410A is automatically (or optionally manually) increased or decreased, depending on the requirement. If the defined confidence threshold 410A increases, the detection sensitivity of the crop plant increases. The confidence threshold value may range from 0 to 1. An increase or decrease of the defined confidence threshold 410A increases changes i.e., increases or decreases the perceptiveness of the modular apparatus 102. For example, at a first defined confidence threshold, say 0.X1, the control device 106 is configured to distinguish between green-looking objects, such as crop plants and weeds. At a second defined confidence threshold, say 0.X2, the control device 106 is configured to further distinguish between a type of crop plant and a type of weed. At a third defined confidence threshold, say 0.X3, the control device 106 is configured to further distinguish between a diseased or a non-diseased crop plant and further distinguish weeds from such diseased or non-diseased crop plants. At a fourth defined confidence threshold, say 0.X4, the control device 106 is configured to further increase crop detection sensitivity such that a discoloured plant or non-discoloured plant, a growth state of the crop plant, a lack of nutrient etc. can be further sensed and additionally distinguish from weeds. Such detection sensitivity is very advantageous and provides a technical effect of increased perceptiveness of the modular apparatus 102 resulting in improved performance of the modular apparatus 102, such as reduced wastage of chemical used for spraying. Alternatively state, the use of the defined confidence threshold 410A significantly improves the perceptive capability of the modular apparatus 102 such that the spraying of chemicals is achieved with improved accuracy and precision for the correct time slots, at correct intended areas or spots and only when required with correct amount of spray and correct selection of a type of chemical irrespective of any change in the surrounding environmental conditions while capturing images of agricultural field. For example, an increase or a decrease in the defined confidence threshold 410A dynamically changes the detection sensitivity of the crop plant increasing the perceptive capability of the modular apparatus 102 making the system fail-safe. In an example, two different chemicals can be loaded in two different chemical storage chambers in the vehicle. A specific chemical type is used only when a discoloured crop plant is detected by a specific nozzle while some nozzles may use another chemical to spray on normal/healthy a crop plant, and remaining nozzles may be deactivated to stop spraying on weeds or unwanted regions. Thus, different applications are made possible by calibration of the defined confidence threshold 410A.

In accordance with an embodiment, the control device 106 is configured to update the defined confidence threshold in response to a change in a quality parameter of the captured plurality of FOVs of the plurality of defined areas of the agricultural field. For example, when there is a change in the quality parameter of the captured plurality of FOVs, that means some images are captured in a sunny environment, a few images are captured in a cloudy environment and a few other images are captured in a rainy environment or there is some shadow, then according to the change in the quality parameter, the defined confidence threshold 410A is dynamically updated to maintain the spray accuracy greater than a threshold, for example, greater than 95-99.99%.

In an implementation, the control device 106 may be configured to operate two or more instances of AI model 120 at different confidence thresholds to perform different actions (e.g., accurately detecting and identifying crop plants, type of crop plants, crop plants with shadow falling on them, crop plants with leaves discoloured or in diseased state, or under different environmental conditions etc) concomitantly in the agricultural field.

In an implementation, the UI element 404 is a sprayer units' control where a front buffer 408A and a rear buffer 408B associated with each image-capture device indicated by UI elements 406A, 406B, and 406C, of the image-capture device 104, may be set. Such setting may occur automatically by the control device 106 or may be done based on a user input. The control device 106 is further configured to determine one or more regions in the agricultural field where to spray a chemical based on the executed mapping of pixel data, the defined confidence threshold 410A, and the front buffer 408A and the rear buffer 408B associated with the image-capture device 104. For example, if a region is determined as 15 cm in length and 15 cm in breadth. Thus, increasing the front buffer 408A to 5 cm may extend the spray region ahead of the crop plant by 5 cm, for example, now 20 cm in length. Similarly, increasing the rear buffer 408B, say by 3 cm, may dynamically extend the spray area to 3 cm from the rear end/behind the crop plant in the direction of movement of the vehicle 108. Similarly, the increase or decrease in the plurality of buffer values causes an implement attached to the vehicle 108 to perform a predefined action on the crop plant, such as uprooting weeds, spraying chemicals, irrigating agricultural field and the like without limiting the scope of present disclosure.

FIG. 5A is an exemplary diagram that represents a generation of a bounding box around a detected and tracked crop plant, in accordance with an embodiment of the present disclosure. FIG. 5A is described in conjunction with elements of FIGS. 1, 2, 3A, 3B, and 4. With reference to FIG. 5A, there is shown an implementation scenario 500A that illustrates the generation of one or more bounding boxes, such as a bounding box 504, around one or more crop plants, such as a crop plant 506. In the implementation scenario 500A, there is shown an agricultural field 502 that includes a plurality of crop plants, such as the crop plant 506 (e.g., a cotton plant) and a plurality of weeds, such as a weed plant 508. The plurality of crop plants and the plurality of weeds may be present unevenly or distributed randomly in the agricultural field 502.

A dotted path 510 illustrates a direction of movement of the vehicle 108 across the agricultural field 502 to detect the plurality of crop plants and further cause an implement to perform a predefined action. For example, the predefined action may be perceptive spot spraying of a chemical on the plurality of crop plants. When the vehicle 108 starts moving across the agricultural field 502 in a first direction until edge of the portion of the agricultural field 502 is reached, the control device (i.e., the control device 106 of the FIG. 1) is configured to detect and track the plurality of the crop plants, such as the crop plant 506.

The detection of the crop plant 506 is based on the predefined confidence threshold and the executed mapping of pixel data of crop plants and weeds from captured images. Thereafter, the control device 106 of FIG. 1) is configured to generate the bounding box, such as the bounding box 504, around the crop plant 506 being tracked and further detect a plurality of buffer values associated with the image-sensor 114. As result, based on the generated bounding box and the detected plurality of buffer values, the control device is configured to cause an implement attached to the vehicle 108 to perform a predefined action on the crop plant, such as precise perceptive spot spraying of chemical on the crop plant 506.

FIG. 5B is an exemplary diagram illustrating detection of a plurality of buffer values, in accordance with an embodiment of the present disclosure. FIG. 5B is described in conjunction with elements of FIGS. 1, 2, 3A, 3B, 4, and 5A. Firstly, the control device 106 is configured to generate a bounding box 504 around the crop plant that is tracked. The bounding box 504 corresponds to an encompassing area that is generated around the detected crop plant 506, as shown and described in FIG. 5A. Thereafter, the control device 106 is configured to detect a plurality of buffer values associated with the image-sensor 114. The plurality of buffer values includes a front buffer value 512 and a rear buffer value 514 that is detected to cause an implement to perform a predefined action on the crop plant 506. In an implementation, the control device 106 is configured to detect the front buffer value 512 to cause the implement to start performing the predefined action on the crop plant from the plurality of the crop plants. In another implementation, the control device 106 is configured to detect the rear buffer value 514 to cause the implement to stop performing the predefined action on the crop plant. In yet another implementation, the control device 106 is configured to detect the front buffer value 512 as well as the rear buffer value 514 to cause the implement to perform and then stop the predefined action on the crop plant 506 after a required duration. However, the duration of the implement to perform the predefined action starts from the front buffer value 512 and ends at the rear buffer value 514. As result, the predefined actions, such as the perceptive spot spraying of chemicals, uprooting the weeds are performed during the required duration of time only.

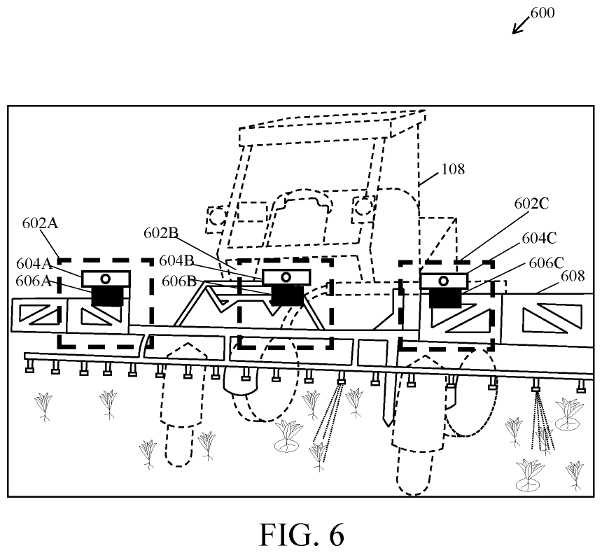

FIG. 6 is a diagram illustrating an exemplary arrangement of a modular apparatus that is mounted on a vehicle, in accordance with an embodiment of the present disclosure. FIG. 6 is described in conjunction with elements of FIGS. 1, 2, 3A, 3B, 4, 5A, and 5B. With reference to FIG. 6, there is shown an exemplary arrangement of the modular apparatus (i.e., the modular apparatus 102 of FIG. 1) that is mounted on the vehicle 108. In an implementation, a plurality of modular apparatuses, such as a first modular apparatus 602A, a second modular apparatus 602B, and a third modular apparatus 602C can be mounted on the vehicle 108. In addition, a boom arrangement 608 is mounted on the vehicle 108 to arrange the plurality of modular apparatuses on the vehicle 108. The boom arrangement 608 comprises or accommodates a redefined number of electronically controllable sprayer nozzles, the first modular apparatus 602A, the second modular apparatus 602B, and the third modular apparatus 602C. A predefined number of electronically controllable sprayer nozzles are configured to spray a chemical on either a plurality of crop plants or weeds perceptively in a controlled manner, depending on an application scenario. Each modular apparatus (i.e., the modular apparatus 102 of FIG. 1) includes a first image-capture device and a control device. For example, the first modular apparatus 602A includes a first image-capture device 604A and a first control device 606A that are connected through a connecting wire. Similarly, the second modular apparatus 602B includes a second image-capture device 604B and a second control device 606B, and the third modular apparatus 602C includes a third image-capture device 604C and a third control device 606C. Therefore, the plurality of modular apparatuses such as, the first modular apparatus 602A, the second modular apparatus 602B, and the third modular apparatus 602C are mounted on the vehicle 108 as per the requirement, such as the area of the agricultural field that is required to be covered in a same time.

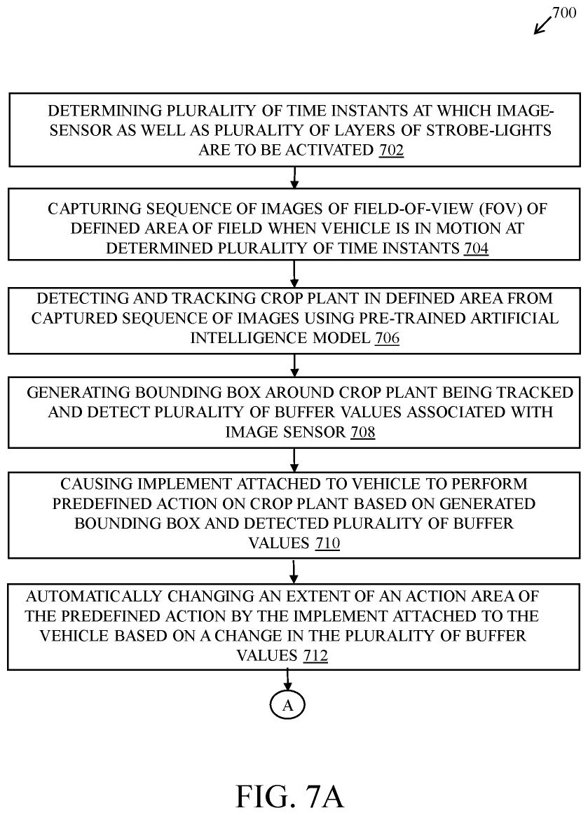

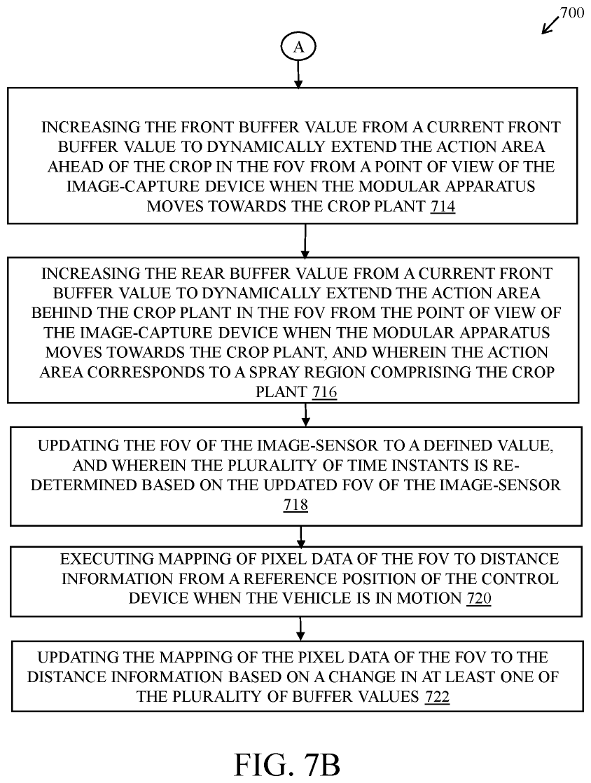

FIGS. 7A and 7B collectively is a flowchart of a method of operation of a modular apparatus mounted in a vehicle, in accordance with an embodiment of the present disclosure. FIG. 7 is described in conjunction with elements from FIGS. 1, 2, 3A, 3B, 4, 5A, 5B, and 6. With reference to FIGS. 7A and 7B, there is shown a method 700 of operation of the modular apparatus 102 mounted in the vehicle 108 (of FIG. 1). The method 700 includes operations 702 to 722. The method 700 is executed by the control device 106 of the modular apparatus 102 (of FIG. 1) that is mounted in the vehicle 108. In an implementation, the method 700 is implemented in the modular apparatus 102.

At 702, the method 700 comprises determining, a plurality of time instants at which the image-sensor 114, as well as the plurality of layers of strobe-lights 112, are to be activated. The plurality of time instants corresponds to the time instants at which the image-sensor 114 is exposed to the plurality of strobe-lights 112 to capture a sequence of images.

At 704, the method 700 further comprises capturing, a sequence of images of a field-of-view (FOV) of a defined area of a field when the vehicle is in motion at the determined plurality of time instants.

At 706, the method 700 further comprises detecting and tracking a crop plant in the defined area from the captured sequence of images using a pre-trained artificial intelligence model. The AI model 120 enables the image-capture device 104 to detect and track the crop plant in the defined area from the captured sequence of the high-quality images of the agricultural field despite of variations in the environmental parameters (i.e., variation in sunlight due to either clouds or rain or shadow of a large object). In an implementation, the detection and tracking of the crop plant in the defined area from the captured sequence of images is further based on a defined confidence threshold that is indicative of a detection sensitivity related to the crop plant.

At 708, the method 700 further comprises generating, a bounding box around the crop plant being tracked and detecting a plurality of buffer values associated with the image-sensor 114.

At 710, the method 700 further comprises causing, an implement attached to the vehicle to perform a predefined action on the crop plant based on the generated bounding box and the detected plurality of buffer values.

At 712, the method 700 further comprises automatically changing an extent of an action area of the predefined action by the implement attached to the vehicle 108 based on a change in the plurality of buffer values. The plurality of buffer values comprises a front buffer value and a rear buffer value.

At 714, the method 700 further comprises increasing the front buffer value from a current front buffer value to dynamically extend the action area ahead of the crop in the FOV from a point of view of the image-capture device 104 when the modular apparatus 102 moves towards the crop plant.

At 716, the method 700 further comprises increasing the rear buffer value from a current front buffer value to dynamically extend the action area behind the crop plant in the FOV from the point of view of the image-capture device 104 when the modular apparatus 102 moves towards the crop plant, and where the action area corresponds to a spray region comprising the crop plant.

At 718, the method 700 further comprises updating the FOV of the image-sensor 114 to a defined value, and where the plurality of time instants is re-determined based on the updated FOV of the image-sensor 114.

At 720, the method 700 further comprises executing mapping of pixel data of the FOV to distance information from a reference position of the control device 106 when the vehicle 108 is in motion.

At 722, the method 700 further comprises updating the mapping of the pixel data of the FOV to the distance information based on a change in at least one of the plurality of buffer values. In an implementation, the defined confidence threshold may be changed to cause a change in detection and tracking of the crop plant in the defined area from the captured sequence of images.

Thus, the disclosed method 700 is technically advanced from conventional methods in terms of improved operation of capturing and processing of the images that are artifact-free even if there are sudden jerks when the vehicle moves in the uneven land area of the agricultural field, where artifact-free image acquisition is ensured even if surrounding environmental conditions keep changing. The method 700 is used to handle the surrounding environmental conditions, such as variation in sunlight due to either clouds, rain, a shadow of a large object, like tree, while capturing an image, change in position of sun throughout the day, light intensity, a time of day when the modular apparatus is operated etc.) and at the same time is able to capture non-blurry images. This in turn provides an improved method 700 that is used to handle surprisingly advanced real-time changes in the surrounding environmental conditions, such as folding of leaves due to wind, drooping of leaves, occlusion by weed, high weed density around the crop plants, and the like.

The operations 702 to 722 are only illustrative and other alternatives can also be provided where one or more steps are added, one or more steps are removed, or one or more steps are provided in a different sequence without departing from the scope of the claims herein. Various embodiments and variants disclosed with the aforementioned modular apparatus (such as the modular apparatus 102) apply mutatis mutandis to the aforementioned method 700.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

What is claimed is:

1. A modular apparatus mounted in a vehicle, comprising:
an image-capture device that comprises a printed circuit board (PCB) having a perforation to accommodate an image-sensor, wherein the PCB comprises a plurality of layers of strobe-lights, wherein each layer of strobe-lights is distributed on the PCB around the perforation to surround the image-sensor when mounted on the PCB; and
a control device configured to control the image-capture device, wherein the control device is further configured to:
determine a plurality of time instants at which the image-sensor as well as the plurality of layers of strobe-lights are to be activated;
capture a sequence of images of a field-of-view (FOV) of a defined area of a field when the vehicle is in motion at the determined plurality of time instants;
detect and track a crop plant in the defined area from the captured sequence of images using a pre-trained artificial intelligence model; and
generate a bounding box around the crop plant being tracked and detect a plurality of buffer values associated with the image-sensor; and
cause an implement attached to the vehicle to perform a predefined action on the crop plant based on the generated bounding box and the detected plurality of buffer values.

2. The modular apparatus according to claim 1, wherein the control device is further configured to automatically change an extent of an action area of the predefined action by the implement attached to the vehicle based on a change in the plurality of buffer values.

3. The modular apparatus according to claim 1, where the plurality of buffer values comprises a front buffer value and a rear buffer value, and wherein an increase in the front buffer value further dynamically extends an action area ahead of the crop plant in the FOV from a point of view of the image-capture device when the modular apparatus moves towards the crop plant, and wherein an increase in the rear buffer value further dynamically extends the action area behind the crop plant in the FOV from the point of view of the image-capture device when the modular apparatus moves towards the crop plant, and wherein the action area corresponds to a spray region comprising the crop plant.

4. The modular apparatus according to claim 1, wherein the control device is further configured to update the FOV of the image-sensor to a defined value, and wherein the plurality of time instants is re-determined based on the updated FOV of the image-sensor.

5. The modular apparatus according to claim 1, wherein the PCB has a first surface and a second surface opposite the first surface, and wherein the plurality of layers of strobe-lights are arranged on the first surface and a plurality of capacitors are arranged on the second surface of the PCB.

6. The modular apparatus according to claim 5, wherein the plurality of capacitors of the PCB are configured to supply power to the plurality of layers of strobe-lights at the determined plurality of time instants.

7. The modular apparatus according to claim 1, wherein the image-capture device further comprises a filter screen to prevent dust particles and UV light to enter the image-sensor.

8. The modular apparatus according to claim 1, wherein the control device is further configured to execute mapping of pixel data of the FOV to distance information from a reference position of the control device when the vehicle is in motion.

9. The modular apparatus according to claim 8, wherein the control device is further configured to update the mapping of the pixel data of the FOV to the distance information based on a change in at least one of the plurality of buffer values.

10. The modular apparatus according to claim 1, wherein the detection and tracking of the crop plant in the defined area from the captured sequence of images is further based on a defined confidence threshold that is indicative of a detection sensitivity related to the crop plant.

11. The modular apparatus according to claim 1, wherein a defined confidence threshold is set in real-time or near real-time via a user interface (UI) rendered on a display device of the vehicle, and wherein the implement attached to the vehicle is caused to perform the predefined action on the crop plant further based on the set defined confidence threshold.

12. A method of operation of a modular apparatus mounted in a vehicle, comprising:
in a modular apparatus:
determining a plurality of time instants at which an image-sensor of the modular apparatus as well as a plurality of layers of strobe-lights around the image-sensor are to be activated;
capturing a sequence of images of a field-of-view (FOV) of a defined area of a field when the vehicle is in motion at the determined plurality of time instants;
detecting and tracking a crop plant in the defined area from the captured sequence of images using a pre-trained artificial intelligence model;
generating a bounding box around the crop plant being tracked and detect a plurality of buffer values associated with the image-sensor; and
causing an implement attached to the vehicle to perform a predefined action on the crop plant based on the generated bounding box and the detected plurality of buffer values.

13. The method according to claim 12, further comprising automatically changing an extent of an action area of the predefined action by the implement attached to the vehicle based on a change in the plurality of buffer values.

14. The method according to claim 12, where the plurality of buffer values comprises a front buffer value and a rear buffer value, and wherein the method further comprises:
increasing the front buffer value from a current front buffer value to dynamically extend an action area ahead of the crop in the FOV from a point of view of the image-sensor when the modular apparatus moves towards the crop plant.

15. The method according to claim 14, further comprising increasing the rear buffer value from a current front buffer value to dynamically extend the action area behind the crop plant in the FOV from the point of view of the image-sensor when the modular apparatus moves towards the crop plant, and wherein the action area corresponds to a spray region comprising the crop plant.

16. The method according to claim 12, further comprising updating the FOV of the image-sensor to a defined value, and wherein the plurality of time instants is re-determined based on the updated FOV of the image-sensor.

17. The method according to claim 12, further comprising executing mapping of pixel data of the FOV to distance information from a reference position of a control device of the modular apparatus when the vehicle is in motion.

18. The method according to claim 17, further comprising updating the mapping of the pixel data of the FOV to the distance information based on a change in at least one of the plurality of buffer values.

19. The method according to claim 12, wherein the detection and tracking of the crop plant in the defined area from the captured sequence of images is further based on a defined confidence threshold that is indicative of a detection sensitivity related to the crop plant.

20. The method according to claim 19, further comprising changing the defined confidence threshold to cause a change in detection and tracking of the crop plant in the defined area from the captured sequence of images.
